(19) United States
(12) Patent Application Publication
(10) Pub. No.: US 2006/0196105 A1
(43) Pub. Date: Sep. 7, 2006

(54) Retrievable Compound Hook and Rig

(76) Inventor: Gabriel Gary Michlitsch, Denver, CO (US)

Correspondence Address: KYLE W. ROST, 5490 AUTUMN CT., GREENWOOD VILLAGE, CO, 80111, US

(21) Appl. No.: 11/164,816

(22) Filed: Dec. 6, 2005

Related U.S. Application Data
(60) Provisional application No. 60/593,080, filed on Dec. 7, 2004.

(51) Int. Cl. A01K 83/00; A01K 97/24

(52) U.S. Cl. 43/44.83; 43/44.82; 43/43.16; 43/17.2

(57) ABSTRACT

A compound hook with forward facing hook tines and a conventional front end line attachment point is provided with a rear support structure defining a rear line attachment point. The hook is rigged with a first fishing line attached to the front line attachment point and a second fishing line attached to the rear attachment point. The second line has sufficiently greater length to remain slack while the first fishing line is tensioned to pull the hook forward. If an obstacle snags the hook, continued pulling on the first fishing line snap or slacks the first line, activating the second line to operate in non-slack mode. The second line then pulls the hook from the rear, turning the hook into a reversed position such that the hook tines face away from the forward direction of travel. The first and second fishing lines can be first and second leaders attached to a single main fishing line, wherein the first leader is weaker than the main fishing line.

### BACKGROUND OF THE INVENTION

1. Field of the Invention

The invention generally relates to fishing and to compound hooks and rigs for compound hooks. In a more specific aspect, the invention relates to snagging hooks and rigs with multiple lines or leaders attached to hooks and rigs.

2. Description of Related Art Including Information Disclosed Under 37 CFR 1.97 and 1.98

A simple fishhook is formed of a shank with an eye on one end for receiving a leader or fishing line. A second and opposite end of the shank forms a reverse curve and terminates in a barbed tip. The resulting hook is approximately j-shaped, such that it has two legs, wherein the shank is the major leg and the barbed tip is on the minor leg. The eye is at the top of the major leg, at the top of the “J” shape.

A compound fishhook is formed of a plurality of barbed, hook-shaped tines joined together. Frequently three tines form a compound hook, although more or fewer can be used. The tines may be equally distributed around the periphery of the compound hook. All tines may extend from a common shank or central shaft having a single eye, or several simple hooks may be combined by having their shanks united into a common central shaft, such as by soldering or brazing. However, even when simple hooks are combined to form a compound hook, the shank or central shaft carries only one eye.

Compound hooks are used in several applications. A fishing lure may carry one or more compound hooks. Snagging hooks typically are compound hooks combined with a sinker weight. While a fishing lure is designed to glide through a body of water between top and bottom surface, a snagging hook is designed to be dragged along the bottom surface of the body of water.

The sinker weight of a snagging hook usually is fixed to the central shaft to ensure that the snagging hook will rest on the bottom. The eye on the central shaft is connected to a leader or fishing line that enables the fisherman to pull the snagging hook with the eye in a leading direction. The barbed tips or tines face the same direction as the eye and advance point-first as the fisherman pulls the fishing line attached to the eye. A bottom-dwelling fish may be snagged by one of more of the tines and pulled with the snagging hook back to the fisherman. Unlike a baited hook or lure, a snagging hook uses no bait and the fish do not swallow the hook. Fish are captured when they are impaled on a tine as the snagging hook is dragged along the bottom. After spawning, salmon tend to dwell on the bottom and can be captured in this way.

A problem with snagging hooks is that they can be dragged substantially in only one direction, which is toward the fisherman with the eye in leading direction and the hook points aimed in the leading direction. Of course, the hooks are prone to engage anything in their path as they are dragged along the bottom with points in leading direction. Obstacles of all sorts can be found on the bottom of a body of water. Once a snagging hook engages an object, it is difficult to disengage the object unless the object successfully can be dragged to the fisherman. Of course, some objects are too big, too heavy, or too firmly anchored to be dragged. If the fisherman cannot free the hook from such an object, he will have to abandon the snagging hook and some portion of the rig and line. Similar problems occur when a fishing lure engages an obstacle.

It would be desirable to have a means for remotely disengaging a compound hook from an object that cannot be dragged. The ability to disengage the hook would permit the recovery of at least some hooks that hit obstructions. Recovering a snagging hook or lure is desirable because such a hook or lure has value. Also, because a compound hook includes more than one hook point, it is likely that at least some of the barbed tines are exposed and not safely engaged in the snagged object. Thus, an abandoned lure or snagging hook presents a continuing, residual danger to humans and animals that may later encounter it. Minimizing the number of abandoned lures and snagging hooks is desirable.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide a means for disengaging a compound hook from an obstacle.

More specifically, an object of the invention is to provide a means for selectively and remotely changing the orientation of a compound hook with respect to its path of towed travel, so that points of the hook may be freed from an obstacle.

According to the invention, a compound hook is adapted to be recovered from snags. The hook includes conventional elements such as a front shank carrying a plurality of hook tines pointing generally in a forward direction. The front shank extends forwardly of the tines and defines a front attachment suited to be joined to fishing line. The invention provides the improvement of a rear support structure that extends rearward of the tines and defines a rear attachment point suited to be joined to fishing line. In use, fishing line is attachable to the front and rear attachment points in a manner that allows the rear attachment point to be pulled to leading position in which the hook tines point generally in a rearward direction, aiding recovery of the hook from snags.

Another aspect of the invention is a method of configuring and rigging a compound hook and recovering the hook in case the hook becomes snagged. According to conventional practice, the hook carries a plurality of hook tines that point in the direction of the front end of the hook. A primary leader connects the front end of the hook to a main fishing line. This conventional configuration is improved by adding a rear support structure that extends behind the hook tines and includes a rear attachment point for fishing line. The improvement is rigged by connecting an alternate leader between the rear attachment point and the main fishing line. The alternate leader is of sufficient length to be in slack condition when the main fishing line and primary leader are active for pulling the hook from its front end in tension. If the hook becomes snagged, the primary leader can be deactivated and the alternate leader can be activated through application of sufficient predetermined force on the primary leader via the main fishing line. Thereafter the main fishing line pulls the hook via the alternate leader. The activated alternate leader reverses the directional orientation of the hook by pulling forward the rear attachment point, thereby bringing the rear attachment point to a leading position. The hook is then recovered by pulling it forward in reversed orientation with hook tines facing rearwardly.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a side elevational view of a snagging hook and rig as it approaches engagement with an underwater obstacle as the hook is dragged on the bottom of a body of water.

FIG. 2 is a view similar to FIG. 1, showing the snagging hook engaged in an obstacle and showing the rig actuated to change the orientation of the hook along its path of dragged travel.

FIG. 3 is a view similar to FIG. 1, showing the snagging hook and rig in a reoriented position free of the obstacle, and also showing the hook and rig in phantom, in a further reoriented position free of the obstacle.

FIG. 4 is a side elevational view of a rigged compound hook constructed according to the invention, and showing in schematic form several devices for deactivating a primary leader.

FIG. 5 is an exploded side elevational view of a compound hook constructed according to one possible plan.

FIG. 6 is a side elevational view of a snagging hook constructed with an attached sinker weight that also establishes a trailing end eye.

### DETAILED DESCRIPTION OF THE INVENTION

One embodiment of the invention is applied to a compound hook of a type known as a snagging hook. Conventionally, the snagging hook is configured to be dragged or towed in a forward direction by a fish line attached to a front or first attachment point, located in a front end position so as to present the hook points when the hook is moved in the forward direction. The invention provides a second or rear attachment point carrying an alternately actuated rigging that is selectively and remotely actuated when the snagging hook becomes snagged to such a degree that it can no longer be pulled in the forward direction. When the alternative rigging is active, the hook points are presented in a non-leading position and preferably in a trailing position.

The invention produces a reorientation of the snagging hook in the direction of forward travel. Thus, the fisherman continues to drag the snagging hook in substantially the only available direction of drag, which is forward, towards himself. However, after the reorientation, the snagging hook is turned or reversed in position with respect to this available direction of forward motion. In the reversed position, the points of the hook often can be pulled free of an obstacle such that the snagging hook can be recovered.

An aspect of the invention is that a compound hook in normal use is pulled by its front end in a forward direction. In the special circumstance when the hook is snagged on an obstacle, the hook can be reversed in position with respect to an attached fishing line. After the reversal, the fishing line again pulls the compound hook in a forward direction, but now the back end of the hook leads. The following terms will be used to describe the structure of the hook, the relative orientation of the hook to the fishing line, and direction of movement. “Proximal” will refer to the portions of components nearer the fisherman with respect to an orientation wherein the hook has its forward end nearer the fisherman. “Distal” will refer to the portions of components more distant from the fisherman with respect to an orientation wherein the hook has its forward end nearer the fisherman. “Front” or “forward” can refer to the end of the hook toward which the hook points are generally directed. “Forward” also may refer to a direction of motion wherein the hook is pulled by the main fishing line, typically toward the fisherman. “Rear” will refer to the end of the hook generally opposite from the direction of the hook points. “Rearward” may refer to the relative direction of the rear end of the hook. “Leading” and “trailing” will refer to relative positions of components with respect to a forward direction of motion, such as motion imparted by pulling on the main fishing line. Therefore, the opposite ends of the hook variously may be in a “leading” or a “trailing” position, depending upon whether the front or rear end of the hook is nearer the fisherman.

A snagging hook 10 includes several conventional elements that are useful to achieve the normal functions of a snagging hook. An elongated central shank 12 approximately lies along or establishes a central longitudinal axis of the snagging hook and forms an eye 14 for attaching to a fishing line at a front or proximal end of the shank 12. The shank 12 may be a part of one or more hook tines 16 or, in certain embodiments, the shank 12 may carry one or more hook tines 16. Typically, a shank 12 is a part of or connected to a plurality of at least three hook tines 16, which may be radially distributed about shank 12 with approximately equal angular separations. Thus, the snagging hook is a compound hook.

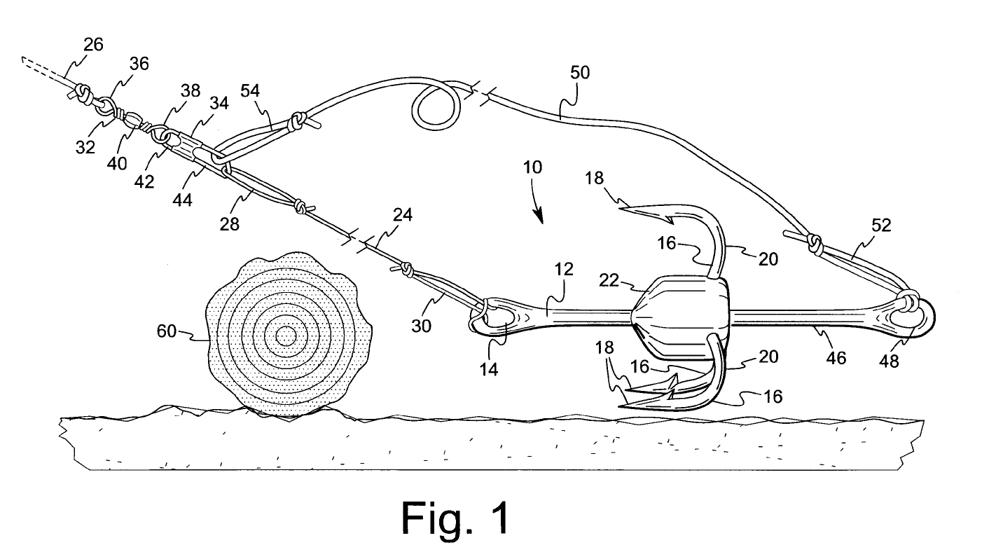

The three hook tines 16 are useful to establish a dragging base for supporting the hook 10 against the ground on two tines while the third is upwardly exposed, as suggested by FIG. 1. Each tine 16 includes a sharply pointed end or barbed tip 18 oriented to face the front or proximal direction established by the position of eye 14 on shank 12. A central portion or base 20 of a hook tine 16 typically is shaped in a bend or curve that interconnects the hook tip 18 and shank 12. Relative to points 18, the base 20 is closer to the distal end of the snagging hook. If required, a sinker weight 22 is attached to the shank 12. This combination of an eye 14 in a front position to a compound array of tines 16 having pointed tips facing in the front direction defines the common configuration of known snagging hooks.

According to conventional methods of use, a fishing line is connected to eye 14. The term, “fishing line,” is known to apply to many available products and may encompass any or all of them and possibly additional types of members. In a broad sense, a fishing line is any type of flexible, elongated member that is capable of interconnecting a hook, lure, or the like with a control apparatus such as a fishing rod, reel, or even the human hand, as desired. Various types of rope, cord, string, fiber, and filament are known for this use, and the term may apply to other materials now known or as may be developed in the future.

For convenience of description and not as a limitation, fishing line can be described as being either main line or leader. “Main line” refers to fishing line of a relatively major length, while “leader” refers to fishing line of a relatively minor length. Main line can be used without leader, but leader is an optional convenience. Leader typically is a short, discrete piece of fishing line that interconnects the hook, lure, or the like with the main line. Often the main line carries a snap or connector at its end. The leader interconnects the snap with the hook or lure. Each hook or lure can be provided with its own pre-formed, pre-attached leader, which enables rapid exchange of hooks or lures on the snap of the main line.

In certain types of fishing, the snap may carry a sinker, and the leader allows a hook or lure to be spaced from the sinker. A leader can be of any selected length and typically is chosen to be a length that is convenient to handle or provides the spacing to the snap or sinker that suits the fisherman's preference. Because leaders often are pre-attached to the hooks or lures in a tackle box, the length of a leader typically will be confined to a manageable length according to the fisherman's method of storing unused hooks and lures, so that leaders do not become tangled. A typical leader is substantially shorter than a main fishing line.

If leader is used, a primary leader 24 is connected to a main fishing line 26. A primary leader 24 is a pre-formed, relatively short section of fishing line. Each end of a leader can be pre-formed into a loop to enable rapid attachment to a hook, lure, snap, or the like. Although the opposite end loops of a leader may be identical, for purposes of description the opposite end loops will be referred to as the proximal loop 28 and the distal loop 30. As suggested in FIG. 1, the distal loop is conveniently attached to a hook or lure by threading the loop 30 through a front eye 14 of the hook. Next, the proximal loop 28 of the leader is threaded through the distal loop 30 of the leader. This method of attachment quickly and securely joins a primary leader to a hook or lure. The proximal loop is free for subsequent attachment to a main fishing line 26 by another means, such as a snap.

For convenience, a snap swivel assembly often is used to connect the main fishing line to the proximal loop 28 of primary leader 24. The snap swivel assembly includes a swivel portion 32 interconnected with a snap portion 34. The main fishing line 26 often is knotted to a proximal end ring 36 of the swivel, and a distal end ring 38 of the swivel is engaged with the snap 34. A central barrel 40 of the swivel 32 enables free rotation between the opposite end rings so that the main fishing line does not become unduly twisted. The snap 34 includes a proximal loop 42 that engages the distal ring 38 of the swivel 32. The snap further includes a distal clip 44 that can be manually opened and closed for engaging or disengaging the proximal loop 28 of primary leader 24. The clip operates somewhat like a conventional safety pin. The snap enables the fisherman to quickly and conveniently change the rig on his line, without cutting off the old rig or tying a new knot. The snap also allows the use of a different weight of primary leader 24 than the weight of the main fishing line 26.

The invention provides an alternate or supplemental line attachment means that extends rearward or is rearwardly offset from the tine bases 20 of the snagging hook 10. A suitable rear support structure is a rear shank 46, extending rearwardly, substantially coaxially with front shank 12. As alternatives to a single shank 46, other equivalent structures might include cage or multiple arms extending rearwardly from the tines. The alternate line attachment means can be a second or rear eye 48 defined near the distal end of shank 46. The preferred position for the eye 48 is at an axially offset position from tine bases 20. The rear eye 48 may lie approximately on a rearward projection of a longitudinal centerline axis of the snagging hook 10 through shank 12 so as to operate equally well regardless of the rotational position of the snagging hook. A suitable rear shank 46 might be a unitary extension of front shank 12. Another embodiment of the rear shank 46 may be a separate shank connected to any of shank 12, one or more tines 16, or sinker 22, as desired. The axial offset of eye 48 from tine base 20 may be similar in dimension to the distance between the tine base 20 and front eye 14.

The rear attachment point exemplified by eye 48 is connected to a main fishing line 26 in a manner that permits the main fishing line to selectively turn the hook 10 end-for-end, bringing the rear aperture to a leading position. The main fishing line then can drag the snagging hook forward with the rear attachment point located in leading position.

One suitable mode of connection employs an alternate leader 50 attached at a distal loop 52 to rear eye 48. A proximal loop 54 attaches the leader 50 to snap 34. Thus, as shown in FIG. 1, the snagging hook 10 is attached to fishing line 26 both by primary leader 24 and by alternate leader 50. The leaders are sized or otherwise arranged such that only one leader is in pulling service at one time. If the primary leader is in pulling service, the main line should then pull the hook from its front end. If the alternate leader is in pulling service, then the main line should pull the hook from its rear end. For convenience, the proximal loops of both leaders are engaged in a single snap 34, although multiple snaps or swivel snap assemblies can be employed, if desired. Alternatively, both leaders can be directly attached to the end of the main fishing line 26, such as by knots.

The snagging hook 10 is equipped with suitable lines or leaders to perform as a novel snagging rig. The fishing line or leader connected to the opposite ends of the snagging hook 10 is selected for particular relative strength and length. Because the normal usage of the snagging hook requires that the hook 10 be dragged from its proximal end, such as by eye 14, the fishing line or primary leader joined to eye 14 is of an overall shorter length than the fishing line or leader joined to eye 48. This can be accomplished by using the two leaders 24 and 50, both attached to the single snap 34, or by an equivalent rigging. The alternate leader 50 is longer than the combined lengths of primary leader 24 plus the distance between eye 14 and eye 48. For example, primary leader 24 may be six inches in length and snagging hook 10 may be two inches in length between eyes 14 and 48. The alternate leader 50 may be nine inches or more in length, which provides at least about one inch of greater overall length. Thus, when main fishing line 26 is in tension and exerts pulling force on snap 34, primary leader 24 normally will be in corresponding tension to pull the snagging hook by front eye 14; and alternate leader 50 will be slack.

According to one method of rigging, the strength, weight, or breaking point of primary leader 24 is chosen to be less than the strength, weight, or breaking point of main fishing line 26. The strength difference is chosen as one method of deactivating the primary leader from pulling service. The different strengths ensure that primary leader 24 will tend to be snapped under tension before main fishing line 26 snaps. When breaking deactivates the primary leader, the alternate leader automatically is activated into pulling service. Alternate leader 50 can be of any desired relative strength, although strength similar to that of the main fishing line is a good choice. Leader and fishing line tend to be inexpensive and easily replaced. Thus, a system for recovering a compound hook by breaking the primary leader is practical and economical.

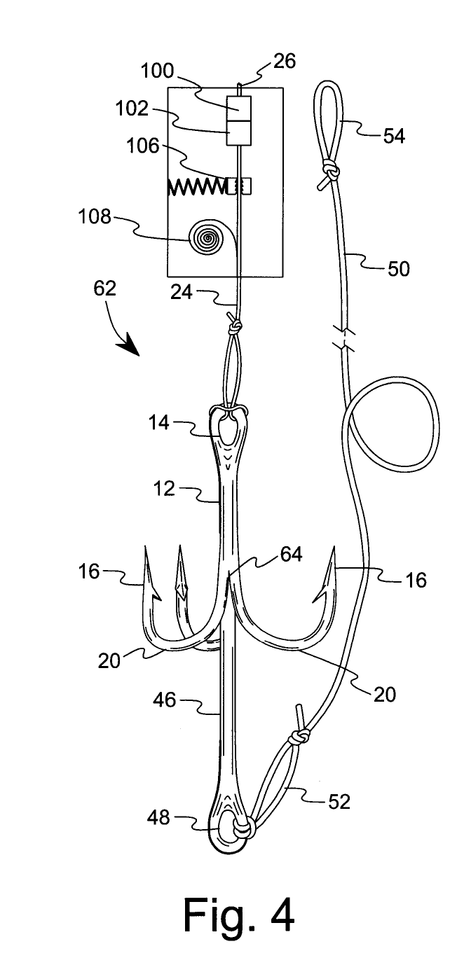

Additional rigging devices and methods appear in schematic form in FIG. 4. According to one such method of rigging, a mechanical device may deactivate the primary leader at a selected point along the primary leader or anywhere between the hook and the main fishing line. Such a device might connect the primary leader to the hook or to the main fishing line or be interposed in the length of the primary leader. The device provides a means for deactivating the primary leader under preselected conditions, such as a preselected force exerted along the main fishing line.

A deactivating device might break or separate the primary leader or it may release or further extend the primary leader upon encountering a predetermined tension in the main fishing line. An example of such a tension release device is a junction in the path of the primary leader formed by a pair of strong magnets 100, 102, shown in FIG. 4. For example, the main fishing line 26 might carry one magnet 100 and the proximal end of the primary leader might carry the other magnet 102. At a predetermined tension between the magnets 100, 102, the magnets would separate, deactivating the primary leader.

Another such device might be a spring-loaded clamp 106 held from the main fishing line and selectively clamping or releasing the proximal end of the primary leader. The clamping tension could be either fixed or adjustable. Under a predetermined line tension or pulling force, the proximal end of the primary leader would be pulled free of the clamp, deactivating the primary leader.

Still another deactivating device might be a reel 108 or other line storage device responsive to a predetermined tension to discharging an additional, previously stored length of primary leader. The quantity of extra line that is released could result in the primary leader being sufficiently long that the alternate leader is brought under tension by the main fishing line without requiring a discontinuity in the primary leader. However, a slack primary leader might catch on an obstacle. Therefore, deactivating devices and methods that produce a discontinuity in the primary leader are preferred.

As shown, many different means might be employed to deactivate the primary leader from pulling service. Each is effective to release the front end of the hook from a tensioned relationship with the main fishing line, sufficiently that the alternate leader can pull the rear end of the hook into a leading position. Hence, while breaking the primary leader is a practical and inexpensive method, another device or method may deactivate the primary leader and activate the alternate leader.

FIG. 1 best shows the snagging rig in normal operation. The lengths of both leaders are not drawn to scale. A central broken-away area in each leader represents possible additional length. Main line 26 acts through primary leader 24 to pull or drag the hook 10 for forward movement. Alternate leader 50 is longer than primary leader 24 plus the length of hook 10 between eyes 14 and 48. Alternate leader 50 is slack. Fishing line 26 is stronger than primary leader 24 so that primary leader 24 is prone to fail in tension before main fishing line 26 would snap.

The hook 10 is shown resting against the ground on two tines 16, while a third tine is exposed at the top of the hook. The hook points 18 extend in the front axial direction of proximal eye 14. The drawing also shows an obstruction 60 in the forward path of the hook. Continued movement from right to left in the view of FIG. 1 will bring the hook 10 into engagement with the obstruction. One or more hook points 18 could engage and become snagged in the obstruction.

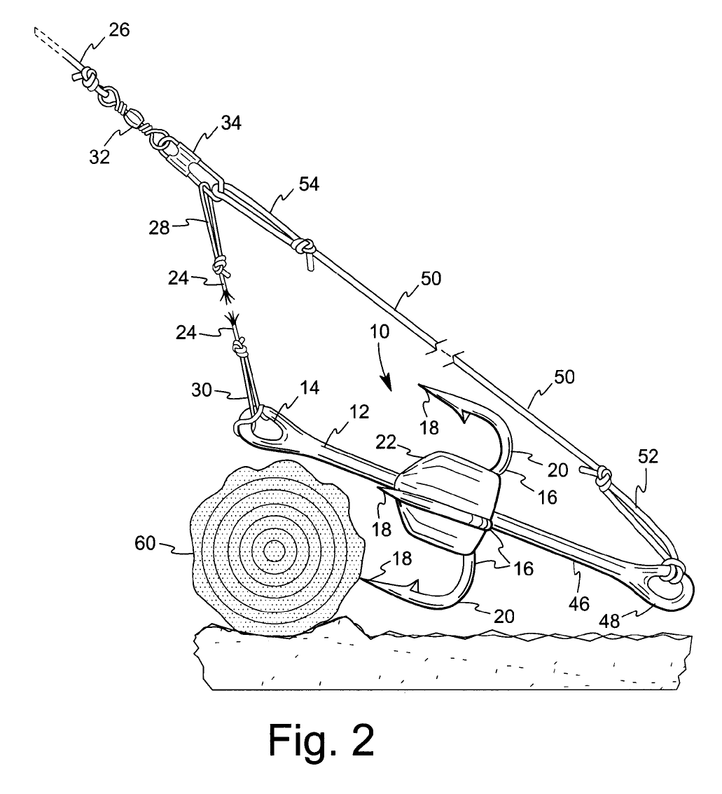

FIG. 2 best shows that the alternate rigging is selectively actuated to change the axial orientation of the hook. When the hook is snagged on an obstacle 60, as illustrated, the fisherman may elect to actuate the alternate rigging by pulling on fishing line 26 with sufficient force to snap primary leader 24. Thus, FIG. 2 shows primary leader 24 has been broken. The lengths of the broken leader ends are not to scale but merely illustrate the broken condition of primary leader 24. Because primary leader 24 is less strong than main fishing line 26, the leader reliably can be broken in preference to breaking the fishing line.

When primary leader 24 breaks, alternate leader 50 is actuated into service. Continued pulling on the fishing line 26 places alternate leader 50 in tension. The fishing line 26 exerts a pulling force, generally from a direction laterally angled to the former direction of forward motion. The pulling force is applied to the rear eye 48. The resulting tendency of such continued pulling is to substantially axially reverse the hook, end-for-end. Where one or more tine points 18 are snagged in an obstruction 60, the snagged tine point 18 might serve as a fulcrum to guide the hook through a pivotal, end-for-end reversal.

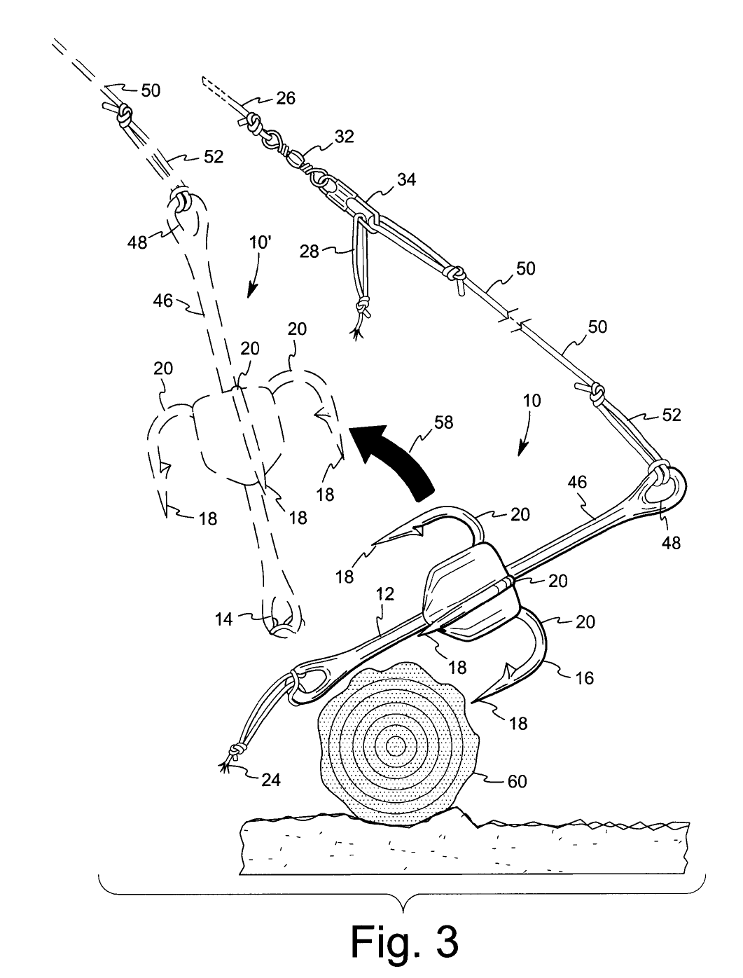

FIG. 3 shows the hook 10 after initiating an end-for-end re-orientation of position. The solid-line view of hook 10 in FIG. 3 shows that continued pulling on line 26 has raised the rear eye 48 of the hook 10 to release tine point 18 from forward engagement with obstacle 60. With additional pulling on fishing line 26, the snagging hook 10 will re-orient as suggested by the sweep of arrow 58 to the position of the phantom hook 10′ shown in FIG. 3, whereby eye 48 moves to the leading end position of the snagging hook. Notably, the bases 20 of tines 16 now lead hook points 18. The bases 20 are smoothly curved and not prone to snag any other obstacles. The fisherman is likely to recover the hook 10′ without further snagging problems. The fisherman need only replace the shorter primary leader 24 and the snagging rig is ready for reuse in fishing.

Various embodiments of the compound hook 10 may prove to be commercially desirable. As on option, the hook 10 does not require the attachment or presence of a sinker weight at point-of-sale. Many fishermen prefer to adapt a compound hook for use as a snagging hook by adding a suitable sinker weight. A sinker weight is easily applied by pouring molten lead around a portion of the hook held in a mold. The molten lead can bond together parts of the snagging hook, as desired.

FIG. 4 in part illustrates a compound hook 62 devoid of sinker weight and held together by other means. This hook 62 is suitable to be configured into a snagging hook 10, if desired. FIG. 4 equally illustrates the configuration of a compound hook 62 that is suitable for attachment to a lure, if desired.

The elements of hook 62 are, in most respects, similar to those of snagging hook 10. Similar parts will be assigned numerals previously used in the description of snagging hook 10.

The compound hook structure includes a front shank 12 defining an eye 14 at the proximal end of shank 12. A rear shank 46 defines an eye 48 at the distal end of the shank 46. This embodiment anticipates that the front shank 12 and the rear shank 46 may be sub-portions of a single, axial, central shank. In the alternative, the front shank 12 and the rear shank 46 may be separate components that are joined together. For example, rear shank 46 may be inserted into a pocket or recess at a junction 64 of the plural hook tines 16. The rear shank 46 may be secured at the junction 64 by any known means, which may include adhesive, crimping, soldering, or brazing. Therefore, FIG. 4 establishes that the central shank may be formed as one or more component elements. Where the central shank is formed of plural components, the components may be combined by any means. Where the hook 62 is to be configured for snagging use, the combining means may be a sinker weight.

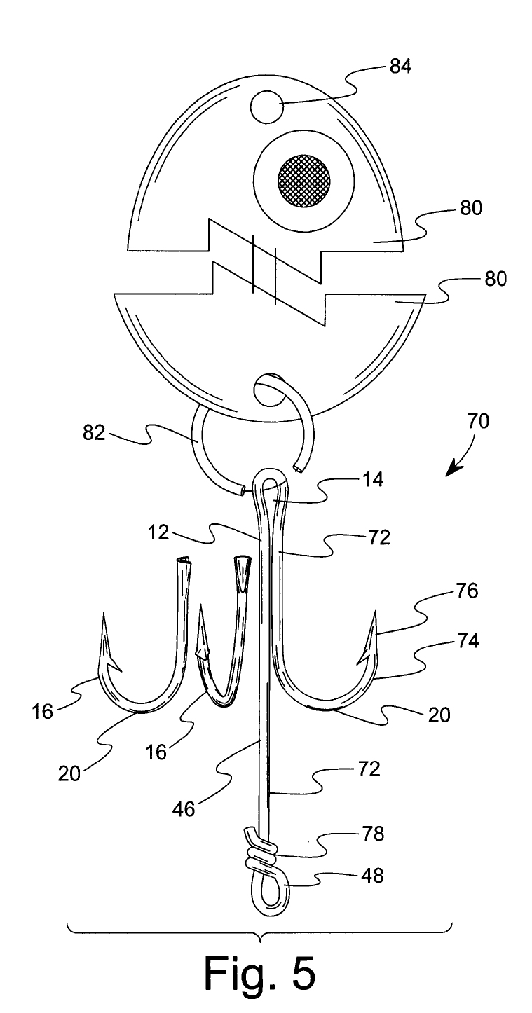

FIG. 5 shows another embodiment and assembly method for formation of a compound hook 70. An elongated wire 72 forms one of the component hook tines 74 and also forms the front and rear shanks 1 2, 46. A first free end of the wire defines the barbed end 76 of hook tine 74. A remainder of the wire is looped to form both eyelets 14 and 48. The wire forms both the front and rear shanks of the compound hook 70.

In this embodiment, the first free end portion of wire 72 extends from hook barb 76 through the base of the J-shaped body of the hook 74. A next portion of the wire extends forwardly to form a portion of front shank 12 and is looped or folded back upon itself to form eye 14. Wire 72 then extends rearward through the length of shank 12. A further portion of wire 72 extends rearward of the level of the base of the J-shaped hook body 74 to form the rear shank 46. A second free end portion of the wire forms the second eye 48. The second free end of wire 72 can be looped or folded back upon itself and fastened to itself as shown by twisted end 78 in FIG. 5 to form the second eye 48.

One or more additional hook tines 16 are attached to the front shank 12 in position to form a compound hook. Suitable means of attaching an additional hook tine 16 includes soldering or brazing. These attaching methods or any similar methods also can be utilized, with or without the addition of individual hook tines 16, to close the perimeters of eyes 14 and 48 by joining the folded-back portions of wire 72 adjacent to each eye.

The preceding description, particularly as supported by FIGS. 4 and 5, has demonstrated that a compound hook 62, 70 with rear shank 46 can be fabricated without requiring the presence of a sinker weight 22. Compound hooks without sinker weights have application in fishing other than as snagging hooks. Notably, such compound hooks are used on fishing lures. FIG. 5 shows fishing lure 80 positioned to be joined to the front eye 14 by a split ring 82. The lure defines an attachment aperture 84 for receiving a primary leader 24.

A compound hook with rear eye 48, used on a lure 80 or in an application other than as a snagging hook, can be retrieved in a manner closely similar to that illustrated in FIGS. 1-3. An alternate leader 50 attaches the rear eye 48 to the main fishing line. The alternate leader 50 is long enough to be slack when the main fishing line, lure 80, and primary leader 24 are towing the hook in a forward direction.

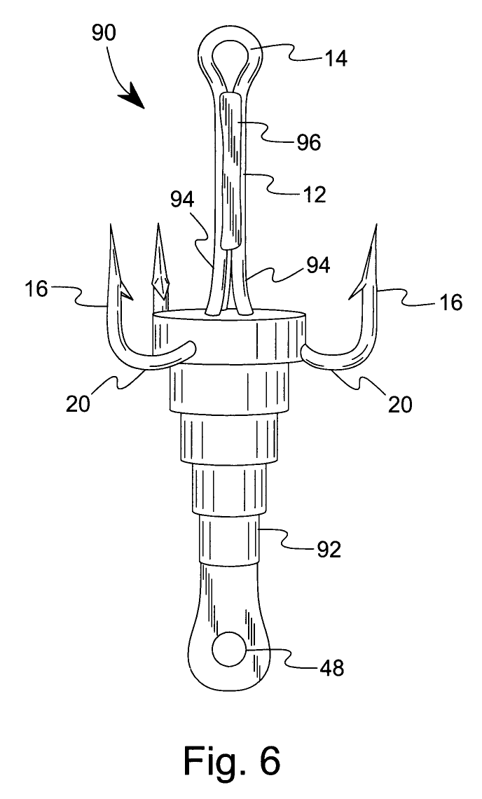

This disclosure, particularly as supported by FIGS. 1-3, has shown that a rear shank can be carried from a sinker weight 22. Still another embodiment, as generally shown in FIG. 6, is a compound hook 90 with the functions of the rear shank performed by a rearwardly elongated sinker weight 92. In this embodiment, the sinker weight 92 is configured to have a portion engaging and secured to the plural hook tines 16 of the compound hook 90. As viewed in FIG. 6, remaining portions of the sinker weight 92 extend rearwardly of the bases 20 of the hook tines 16 to form a tapering, longitudinally extended body that forms the trailing eye 48 at its distal end. In particular, the downwardly tapering sinker weight 92 may be formed of a series of cylindrical tiers in order to obtain favorable structural integrity in the lead material.

The embodiment of FIG. 6 also shows the formation of the front eye 14 and front shank 12 from a common wire 94 that is folded back upon itself. The same common wire 94 may extend from the bottom of the front shank 12 to form two hook tines 16, one at each of two free ends of the wire 94. Optionally, a third hook tine 16 can be attached to shank 12 by a unifying body of solder or brazing material 96, which also or alternatively may close the folded-back portion of wire 94 to define eye 14.

In summary, the disclosure provides a compound hook formed, at a minimum, of a plurality of fishhook tines connected to a suitable supporting means for locating a front eye and a rear eye with respect to the hook tines. The front eye is generally forward of the points of the hook tines and typically is located in-line with a centerline, longitudinal axis of the compound hook, on a centerline shank. The rear eye is generally rearward of the hook tine bases. The rear eye is located in-line with a centerline, longitudinal axis of the compound hook, typically on a centerline shank. In addition, the compound hook generally is formed of at least three hook tines, with hook points generally directed in a single direction that is considered to be toward the front of the hook. Thus, the front eye and rear eye are respectively forward and rearward of the array of hook tines of the compound hook. This arrangement can be suitably rigged as disclosed, above, to be retrievable if a tine point catches on an obstacle.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention.

What is claimed is:

1. In a compound hook adapted to be recovered from snags, formed of a front shank carrying a plurality of hook tines pointing generally in a forward direction, wherein the front shank extends forwardly of the tines and defines a front attachment suited to be joined to fishing line, the improvement comprising:
a rear support structure, extending rearwardly of the tines and defining a rear attachment point suited to be joined to fishing line;
whereby, in use, fishing line is attachable to said front and rear attachment points in a manner allowing the rear attachment point to be pulled to leading position with said hook tines pointing generally in a rearward direction to aid recovery of the hook from snags.

2. The compound hook according to claim 1, wherein said rear support structure comprises a rear shank.

3. The compound hook according to claim 1, wherein said rear support structure defines a rear attachment point comprising an aperture.

4. The compound hook according to claim 1, wherein said front shank and rear shank are unitary.

5. The compound hook according to claim 1, wherein said front shank and rear shank are formed of a wire looped at a front extent of the hook to form said front attachment point and looped at a rear extent of the hook to form said rear attachment point.

6. The compound hook according to claim 5, wherein said wire forms at least one hook tine.

7. The compound hook according to claim 1, wherein:
said front shank is formed of a wire looped at a front extent of the hook to form said front attachment point and forming at least two hook tines; and
said rear support structure comprises a rear shank joined to the front shank in juxtaposition to said at least two hook tines.

8. The compound hook according to claim 1, further comprising a sinker weight.

9. The compound hook according to claim 8, wherein said sinker weight is attached in juxtaposition to said tines.

10. The compound hook according to claim 9, wherein said sinker weight joins said front shank and said rear support structure.

11. The compound hook according to claim 1, wherein:
said rear support structure comprises a sinker weight joined to said tines; and
said sinker weight is longitudinally elongated in an axial direction rearward to the tines.

12. The compound hook according to claim 1, further comprising a rigging enabling said hook to be connected to a main fishing line for reversal in case the hook catches on a snag, wherein the rigging comprises:
a primary leader connected at a distal end thereof to said front attachment point and, in use, connectable at a proximal end thereof to said main fishing line; and
an alternate leader connected at a distal end thereof to said rear attachment point and, in use, connectable at a proximal end thereof to the main fishing line;
wherein said alternate leader is longer than the combined length of said primary leader plus a distance between the front attachment point and rear attachment point, in use allowing the main fishing line to applying a deactivating force to said primary leader while the alternate leader is slack, resulting in the main fishing line thereafter acting on said hook via the alternate leader.

13. The compound hook according to claim 12, wherein:
said main fishing line if of a first predetermined breaking strength; and
said primary leader is of a second predetermined breaking strength less than said first predetermined breaking strength, whereby the primary leader is preferentially breakable with respect to the main fishing line, such that the primary leader can be broken by applying sufficient deactivating force via the main fishing line.

14. A method of configuring, rigging and operating a compound hook for recovery in case said hook becomes snagged on an obstacle, wherein the hook if formed of a plurality of hook tines facing a front end of the hook, and a primary leader connects the front end of the hook to a main fishing line, comprising:
providing a rear support structure extending behind said hook tines and including a rear attachment point for fishing line;
connecting an alternate leader between said rear attachment point and said main fishing line, wherein said alternate leader is of sufficient length to be in slack condition when the main fishing line and primary leader are in tension;
deactivating the primary leader from pulling service upon snagging an obstacle and activating the alternate leader for pulling service;
placing the alternate leader in tension to reverse the directional orientation of the hook by moving the rear attachment point to a leading position;
recovering the hook by pulling it forward in said reversed orientation.

15. The method according to claim 14, wherein said step of deactivating the primary leader is accomplished by breaking the primary leader.
